(19) United States
(12) Patent Application Publication
(10) Pub. No.: US 2024/0403566 A1
(43) Pub. Date: Dec. 5, 2024

(54) FLEXIBLE ARTIFICIAL INTELLIGENCE BASED SYSTEM WITH PROMPT ENHANCEMENT

(71) Applicant: Aible Inc., Pleasanton, CA (US)

(72) Inventors: Arijit Sengupta, San Carlos, CA (US); Richard Cooke, Hayward, CA (US); Joseph Veltkamp, Corte Madera, CA (US); Jonathan Wray, Leander, TX (US); Rodney Butters, Larkspur, CA (US)

(21) Appl. No.: 18/734,127

(22) Filed: Jun. 5, 2024

Related U.S. Application Data
(60) Provisional application No. 63/471,249, filed on Jun. 5, 2023.

(51) Int. Cl. G06F 40/35

(52) U.S. Cl. CPC G06F 40/35

(57) ABSTRACT

Data characterizing a prompt can be received. Data characterizing an enhanced prompt can be generated. A prompt response can be determined by providing the data characterizing the enhanced prompt to an artificial intelligence based model. The prompt response can be provided to a user. Related apparatus, systems, techniques, and articles are also described.

### CROSS-REFERENCE TO RELATED APPLICATIONS

This application claims priority under 35 U.S.C. 119(e) to U.S. Provisional Patent Application No. 63/471,249 filed Jun. 5, 2023, the entire contents of which is hereby expressly incorporated by reference herein.

### TECHNICAL FIELD

The subject matter described herein relates to a system for prompt enhancement for an artificial intelligence based system.

### BACKGROUND

Artificial intelligence (AI) based systems have been deployed to generate outputs to user provided queries or prompts. However, the quality of the output generated by the artificial intelligence system can vary greatly based on the user provided prompt. For example, a generative model configured to generate an image may produce widely different outputs based on a user provided prompt of “draw a red door” in comparison to a user provided prompt of “draw a red door that is rounded and six feet tall for a house in the style of a children's book.” Similarly, a generative model configured to generate a text may produce differing outputs based on a user provided prompt of “write me a song” in comparison to a user prompt of “write me a song in the style of pop music about summer.”

Additionally, the same prompt may provide different outputs and produce outputs of different quality based on the specific artificial intelligence based model that the prompt is being fed into. Additionally, the same prompt may also provide different outputs and produce outputs of different quality based on the settings utilized by the underlying artificial intelligence based model the prompt is being fed into.

Further, an AI based model may produce output that is entirely irrelevant to the conversation or prompt initiated by a user or where the AI based model simply makes up facts in its response, in what is commonly referred to as a hallucination. In hallucinations AI based foundational models simply make up information and present it confidently to a user as if it were fact. At times, these hallucinations may be due in part to the quality of the input to the model by way of the user provided prompt.

### SUMMARY

In some aspects, the techniques described herein relate to a method including: receiving data characterizing a first prompt from a user interface; generating data characterizing a second prompt, where the second prompt is configured to generate a response from an artificial intelligence model that has a greater relevancy than a response from the artificial intelligence model generated by providing the first prompt to the artificial intelligence model; receiving data characterizing a response to the second prompt by providing the data characterizing the second prompt to an artificial intelligence based model; and providing the response to the second prompt in the user interface.

One or more of the following features can be included in any feasible combination. For example, generating the data characterizing the second prompt further includes: modifying the received data characterizing the first prompt based on at least one of a type of the artificial intelligence based model, a setting of the artificial intelligence based model, or a configuration for an enterprise in which the artificial intelligence based model is deployed.

In some aspects, the techniques described herein relate to a method, where the type of the artificial intelligence based model includes at least one of a foundational model, a multimodal model, a reinforcement learning model, a transfer learning model, or a large language model.

In some aspects, the techniques described herein relate to a method, where the setting of the artificial intelligence based model includes at least one of a temperature, a frequency penalty, a top P-value, or a top K-value.

In some aspects, the techniques described herein relate to a method, where the configuration for the enterprise includes at least one of language preferences, or data masking preferences.

In some aspects, the techniques described herein relate to a method, where the language preferences includes tone, cadence, or narrative styles.

In some aspects, the techniques described herein relate to a method, where the configuration for the enterprise includes enterprise specific data.

In some aspects, the techniques described herein relate to a method, where the enterprise specific data includes at least one of sales expenditure, marketing expenditure, revenue, win rate, statistics, inventory levels, logistics datasets, collections metrics, or lead conversions.

In some aspects, the techniques described herein relate to a method, where the first prompt is provided by the user interface in natural language form.

In some aspects, the techniques described herein relate to a method, where the data corresponding to the response to the second prompt is provided to the user interface in natural language form.

In some aspects, the techniques described herein relate to a method, where generating the data characterizing the second prompt further includes: receiving historical user behavior including historical data analysis characteristics; and generating, based on the historical data analysis characteristics, a blueprint for modifying the first prompt into the second prompt.

In some aspects, the techniques described herein relate to a method, where the blueprint is at least partially automatically generated based on metadata.

In some aspects, the techniques described herein relate to a method, where generating data characterizing the second prompt is based at least on user feedback to historical provided prompt responses.

In some aspects, the method, further includes: selecting the artificial intelligence based model based on the second prompt.

In some aspects, a system includes: at least one data processor; and memory coupled to the at least one data processor and storing instructions which, when executed by the at least one data processor, causes the at least one data processor to perform operations including: receiving data characterizing a first prompt from a user interface; generating data characterizing a second prompt, where the second prompt is configured to generate a response from an artificial intelligence model that has a greater relevancy than a response from the artificial intelligence model generated by providing the first prompt to the artificial intelligence model; receiving data characterizing a response to the second prompt by providing the data characterizing the second prompt to an artificial intelligence based model; and providing the response to the second prompt in the user interface.

In some aspects, a non-transitory computer readable storage medium stores computer readable instructions, which, when executed by at least one data processor, causes the at least one data processor to perform operations including: receiving data characterizing a first prompt from a user interface; generating data characterizing a second prompt, where the second prompt is configured to generate a response from an artificial intelligence model that has a greater relevancy than a response from the artificial intelligence model generated by providing the first prompt to the artificial intelligence model; receiving data characterizing a response to the second prompt by providing the data characterizing the second prompt to an artificial intelligence based model; and providing the response to the second prompt in the user interface.

Disclosed is an enterprise-specific prompt generator that can be applied to multiple business applications.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a process for receiving prompt responses from enhanced prompts;

FIGS. 2A-2B are system block diagrams illustrating an example system;

FIGS. 3-7 illustrate various example user interfaces illustrating example implementations of the current subject matter;

FIG. 8 is a flow diagram illustrating an exemplary embodiment of the current subject matter; and

FIG. 9 illustrates an example user interfaces illustrating an example implementation of the current subject matter.

Like reference symbols in the various drawings indicate like elements.

### DETAILED DESCRIPTION

Artificial intelligence (AI) based foundational models may include multimodal models, large language models, chatbots, voice assistants, and the like. While these AI based foundational models are being broadly adopted, they continue to produce outputs of varying quality. The quality of the output generated by the artificial intelligence system can vary greatly based on the user provided prompt to the artificial intelligence system. Some implementations of the current subject matter include generating improved prompts or enhanced queries for use with an artificial intelligence system. The enhanced prompts can provide better outputs from artificial intelligence systems.

In exemplary implementations, the disclosed subject matter may be used to generate enhanced user prompts that are able to utilize context specific language and allow businesses to use artificial intelligence models that are enterprise specific.

AI based generative models may provide different outputs and produce outputs of different quality based on the specific artificial intelligence based model that the prompt is being fed into. For example, the same prompt may not produce the same quality of output in a first artificial intelligence model such as GPT-4 in comparison to a second artificial intelligence model such as PaLM2, and the like.

Additionally, the same prompt may also provide different outputs and produce outputs of different quality based on the settings utilized by the underlying artificial intelligence based model the prompt is being fed into. For example, an artificial intelligence model such as a large language model may produce different outputs for a prompt depending on the underlying settings of the large language model. For example, if the temperature settings of the large language model is changed from low temperature to high temperature, the same prompt may result in a different quality of output.

The quality of a response generated by an artificial intelligence based model may be evaluated on the creativity of the AI response, the amount of hallucinations generated by the AI model, the accuracy of facts produced by the AI model, the responsiveness of the AI model to the prompt, how well the AI followed user instructions, the speed of the response and the like.

In some conventional systems, end users may be provided with examples of better prompts (e.g., documents, websites and videos) and users are encouraged to use those examples while forming their own prompts. However, this does not provide a scalable solution, because the user generated prompts that produce the most relevant outputs by the artificial intelligence model may vary according to the type of the artificial intelligence model and the settings for the artificial intelligence model. Users are also unlikely to follow the examples diligently while creating their prompts.

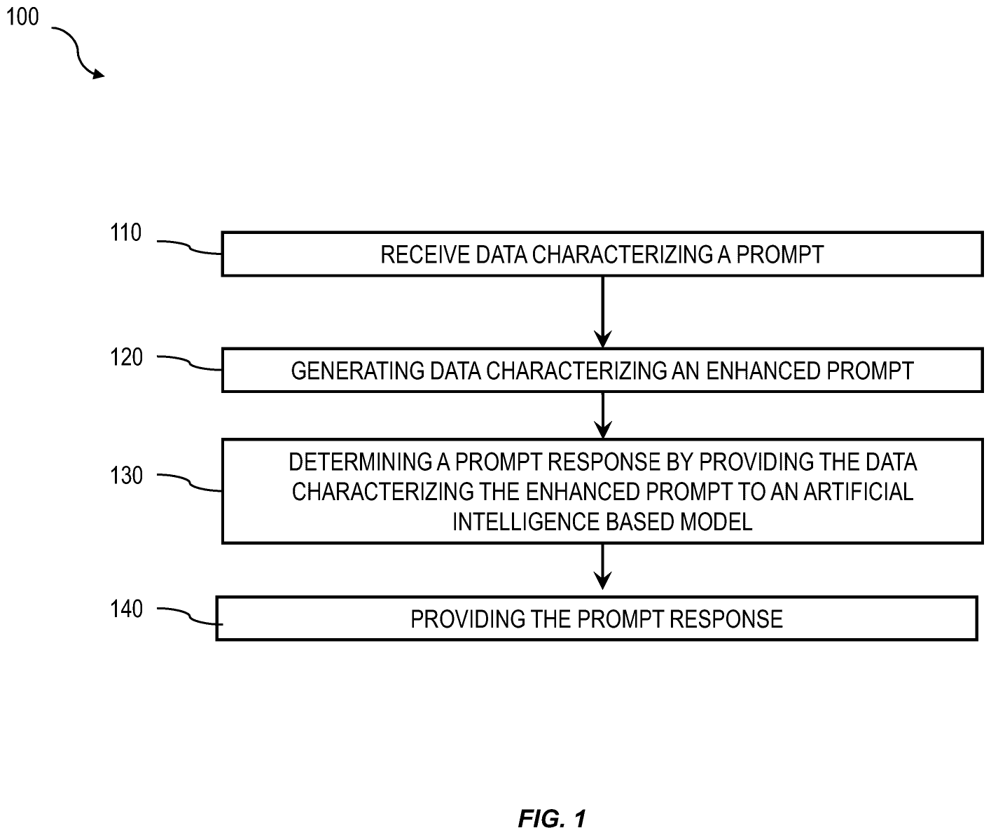

FIG. 1 is a process flow diagram illustrating an exemplary method 100 of generating enhanced prompts for use with artificial intelligence based systems.

In a first step 110 of the exemplary method, data characterizing a prompt can be received. For example, in some embodiments a user interface may be configured to receive a text, voice, or other prompt from a user. In some embodiments, the received prompt may be in natural language form.

In a second step 120 of the exemplary method, data characterizing an enhanced prompt can be generated based on the received data characterizing a prompt. For example, a user may provide a prompt to an artificial intelligence based model such as “what drives higher sales success?” and the disclosed methods can generate an enhanced prompt that may produce better and more relevant responses from the artificial intelligence based model.

In some embodiments, generating the enhanced prompt may include modifying the received data characterizing a prompt based on a type of the artificial intelligence based model. Types of artificial intelligence based models may include GPT-3, GPT-4, PaLM 2, GPT-J, Dolly 2, Gemini, and the like.

In some embodiments, generating the enhanced prompt may include modifying the received data characterizing the prompt based on a setting of the artificial intelligence based model. For example, in a learning language model, settings may include the temperature, frequency penalty, presence penalty, top P-value, or top K-value.

In some embodiment, generating the enhanced prompt may include modifying the received data characterizing the prompt based on a configuration for an enterprise in which the artificial intelligence based model is deployed. For example, in generating the enhanced prompt, enterprise specific practices may be applied. For example, the prompt may be modified to use colloquial or formal language, remove slang terms or the like. Additionally, the enhanced prompt may be configured to mask sensitive or proprietary data that the enterprise does not wish to share with the artificial intelligence based model.

In some embodiments, historical user behavior including historical data analysis characteristics may be received, and a blueprint for guiding user action to modify the prompt may be generated based on the historical user behavior. For example, data characterizing how an expert user navigated and generated user queries may be used to develop a process for generating enhanced queries. For example, the metadata from historical interactions for using queries with an AI model may be used to determine templates that can be used to develop enhanced queries.

In a third step 130 of the exemplary method, a prompt response may be determined by providing the data characterizing the enhanced prompt to an artificial intelligence based model.

For example, the artificial intelligence based model may include a model that is an informational model that has access to enterprise specific information. Enterprise specific information may include data on the variables and parameters that impact key performance indicators for an enterprise. Variables and parameters can include sales expenditure, marketing expenditure, revenue, win rate, statistics, inventory levels, logistics datasets, collections metrics, lead conversions, and the like. The information model can include descriptive models, diagnostic models, predictive models, optimization models, prescriptive models, cost-benefit models, and/or constraint models. Optimization models may include those that balance cost-benefits of predictive models subject to business constraints. The information model may produce one or more charts that provide insight into how an enterprise may be affected under different strategies and cost benefit assumptions. For example, information models may include those discussed in U.S. patent application Ser. No. 16/512,647 filed on Jul. 16, 2019, entitled “ANALYZING PERFORMANCE OF MODELS TRAINED WITH VARYING CONSTRAINTS” the contents of which are hereby incorporated by reference, in their entirety. For example, information models can include a set of models trained on a dataset using a set of resourcing levels, which may specify a condition on outputs of models in the set of models.

In some implementations, the artificial intelligence based model may include a model that is a foundational model, a class of large language models, a generative model, a reinforcement learning model, transfer learning model, generative AI based technologies, and the like. In some embodiments, the artificial intelligence based model may be used on a global learning model that is trained on a vast quantity of data. The artificial intelligence based model may utilize various learning algorithms including supervised learning and unsupervised techniques. The model may be trained on vast quantities of data.

In a fourth step 140 of the exemplary method, the prompt response can be provided. For example, in some embodiments, the prompt response may be provided to a user interface. In some embodiments, the prompt response may be provided to a user interface in natural language form. Accordingly, a user may be able to use conversational language with the described systems and methods.

In some embodiments, the user interface may include any hardware or software components for communication between a user and the system described herein.

Examples of user interfaces include applications, software programs, web applications, downloadable applications, and the like that may be present on a user interface device.

Examples of user interface devices, include, but are not limited to laptops, desktop computers, smartphones, tablets, car service devices, television devices, video game controller systems, coffee machines, refrigerators, and the like. The user interface may be in the form of a voice assistant, chat assistant, email assistant, image generation, and the like. In some embodiments, the user interface may allow for enterprise specific users or enterprise customer users to interact with the prompt response.

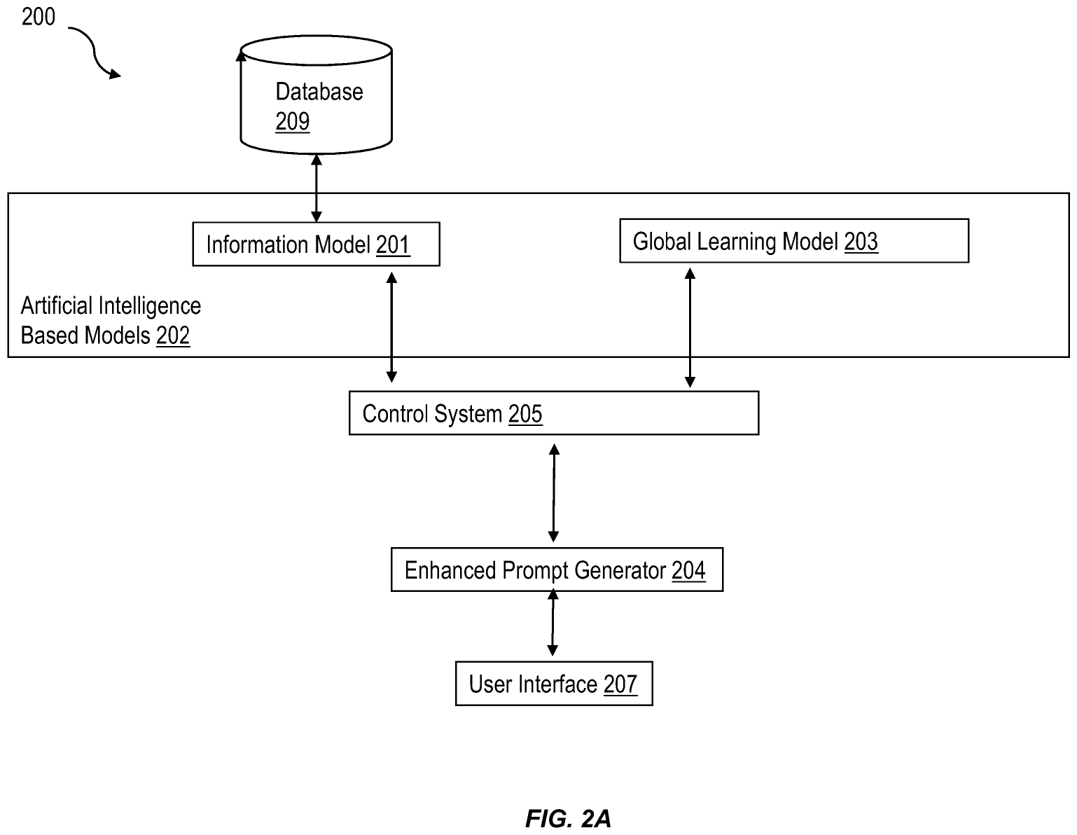

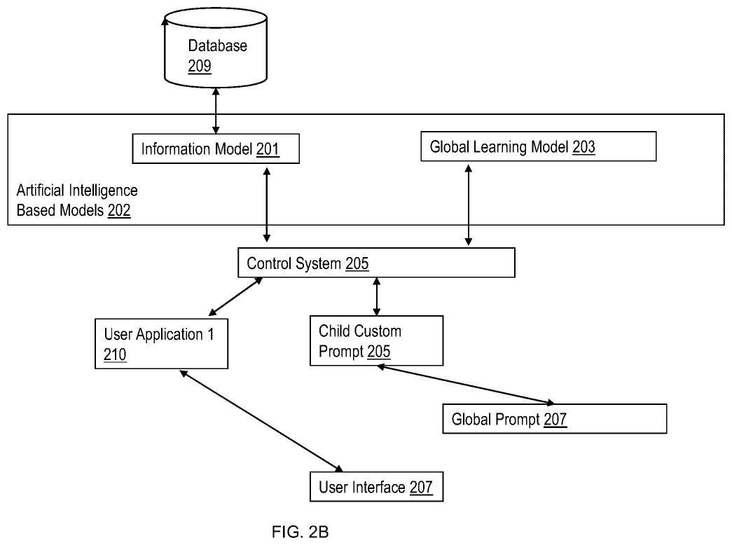

FIG. 2A is a system block diagram illustrating an example implementation of a system 200 for providing enhanced queries. For example, the system 200 may include artificial intelligence models 202, which may include information models 201, and/or foundational or global learning models 203. The artificial intelligence models 202 may be mediated by a control system 205. In some embodiments, the information model 201 may be communicatively coupled to a database 209 that includes enterprise specific data. The control system 205 may interface between the information model 201 and the foundational or global learning model 203. For example, the control system 205 may use the foundational or global learning model 203 to generate human comprehensible insights based on data and parameter sets provided by the information model 201. Additionally, the control system 205 may use the information model 201 to confirm the accuracy of output generated by the foundational or global learning model 203. Additionally, the control system 205 may use the information model 201 to access or edit information in the database 209. Additionally, the user interface 207 may be configured to allow inexpert users to confirm and accept the output of the combined system without requiring any data science expertise. The system 200 also includes an enhanced prompt generator 204 that is configured to provide enhanced queries to at least one of the control system 205, the global learning or foundational model 203, or the information model 201.

FIG. 2B is a system block diagram illustrating a second example implementation of a system 200 for enhanced prompt generation and distribution. As illustrated in FIG. 2B, artificial intelligence based models 202 can include information models 201 and global learning models 203. The artificial intelligence models 202 can be in communication with database 209. A control system 205 can be in communication with a user application.

In some embodiments, a user interacting with a user application 210 may provide the user application 210 with a query that is transmitted to the underlying control system 205. The underlying global learning model 203 can use the provided query to select appropriate data from the information model 201 and provide it to the control system 205. The control system 205 can then provide the information to the global learning model 203.

In this manner, the control system 205 can be configured for both retrieval and processing. For example, during retrieval the control system 205 can provide information to the global learning model 203, have the appropriate data retrieved from the informational model 201 and returned to the control system 205. In some embodiments, the data retrieved from the informational model 201 can be represented in tables, charts, or other structured data formats. During the processing aspect, the control system 205 may provide the data retrieved from the informational model 201 to the global learning model 203 for interpretation.

For example, in accordance with embodiments illustrated in FIG. 2B, a user provided query can state: “I am interested in sales converted by lead source.” The underlying global learning model 203 can identify that the lead source is a channel. The corresponding data can be retrieved from the informational model based on the input from the global learning model. For example, all the data corresponding to the channel may be provided to the control system.

In some embodiments, the information retrieved from the informational model can be used to query the global learning model 203 as an enhanced prompt.

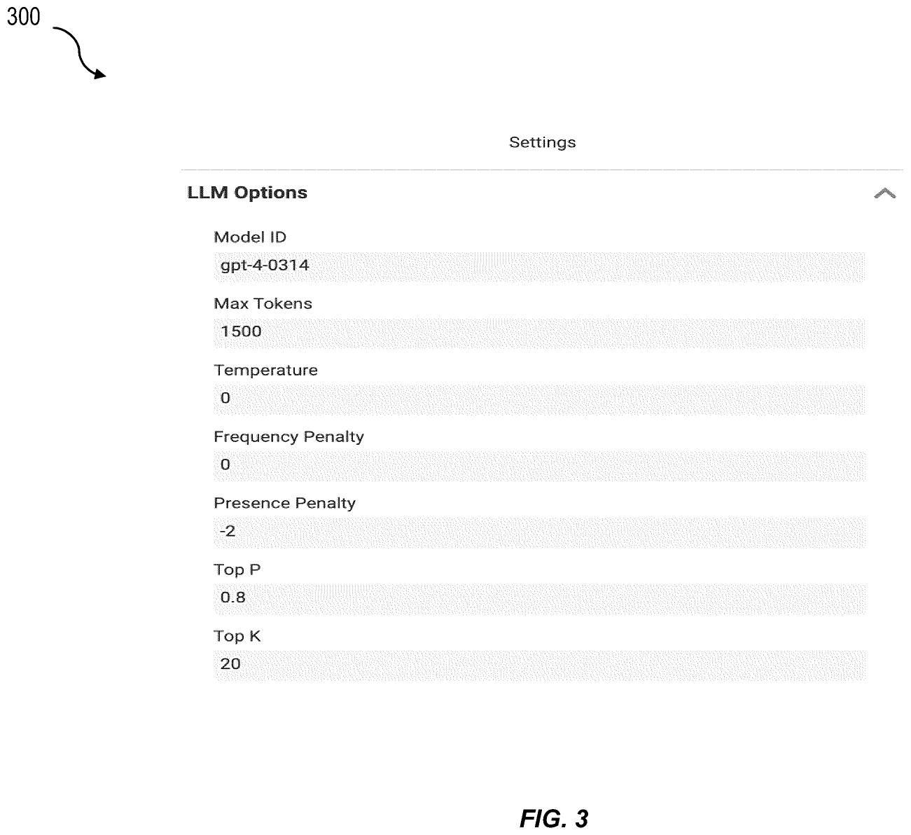

FIG. 3 provides an illustration of an interface 300 that shows settings of an artificial intelligence model that may impact the outcome or responses to a prompt received by the artificial intelligence model. As shown, the quality of the outcomes or responses to a prompt generated by a large language model may be affected based on the settings of the large language model including the temperature, frequency penalty, presence penalty, top p-value, and top k-value for the model. In some embodiments, an enhanced prompt may include settings for the large language model.

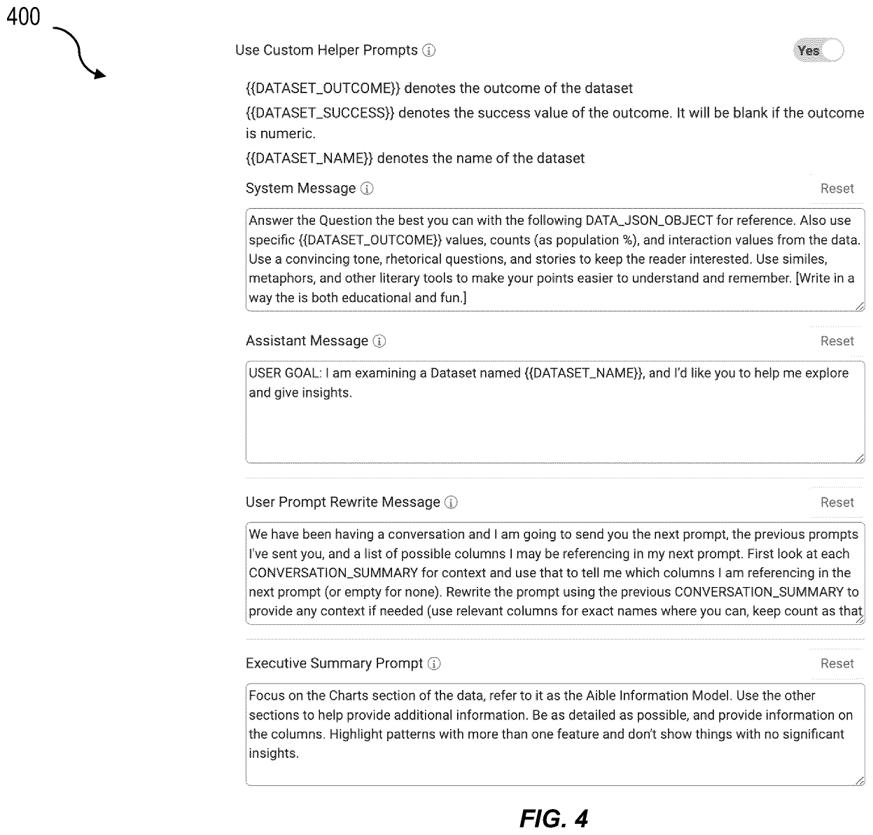

FIG. 4 provides an illustration of an interface 400 that shows enhanced prompts. As shown, a user may provide a generic prompt to an artificial intelligence system that is integrated with an enterprise. For example, the user may ask the system to explore a dataset. The enhanced prompt may provide a more robust set of instructions to the artificial intelligence based model. For example, the enhanced prompt may include the dataset object, indicate that the outcomes of the dataset need to be discussed, and parameters on how the response should be formulated. For example, parameters on how the response should be formulated may indicate a tone, cadence, narrative styles and the like that should be used in formulating the response. The enhanced prompt may also help reduce hallucinations via ‘grounding’ the artificial intelligence system to respond to the user prompt solely based on information in the provided dataset object.

In some implementations, the current subject matter can be used with information models that are used with large language models to deliver analytical output without hallucinations. For example, a prompt generator can be used with the information and large language models described in U.S. Provisional Application No. 63/452,417 entitled ENTERPRISE-SPECIFIC CONTEXT-AWARE AUGMENTED ANALYSIS filed on Mar. 15, 2023, which is hereby incorporated by reference in its entirety. For example, the prompt generator can be used to provide enhanced prompts to information models, which may be descriptive, diagnostic, predictive, and prescriptive models. Information models may be based on the unique business cost-benefit tradeoffs and business constraints. In some embodiments, the disclosed prompt generator can be used to define which type of information model, or other functions such as data retrieval, data entry, and the like can be used in conjunction with large language models or other foundational models to enhance enterprise specific tasks.

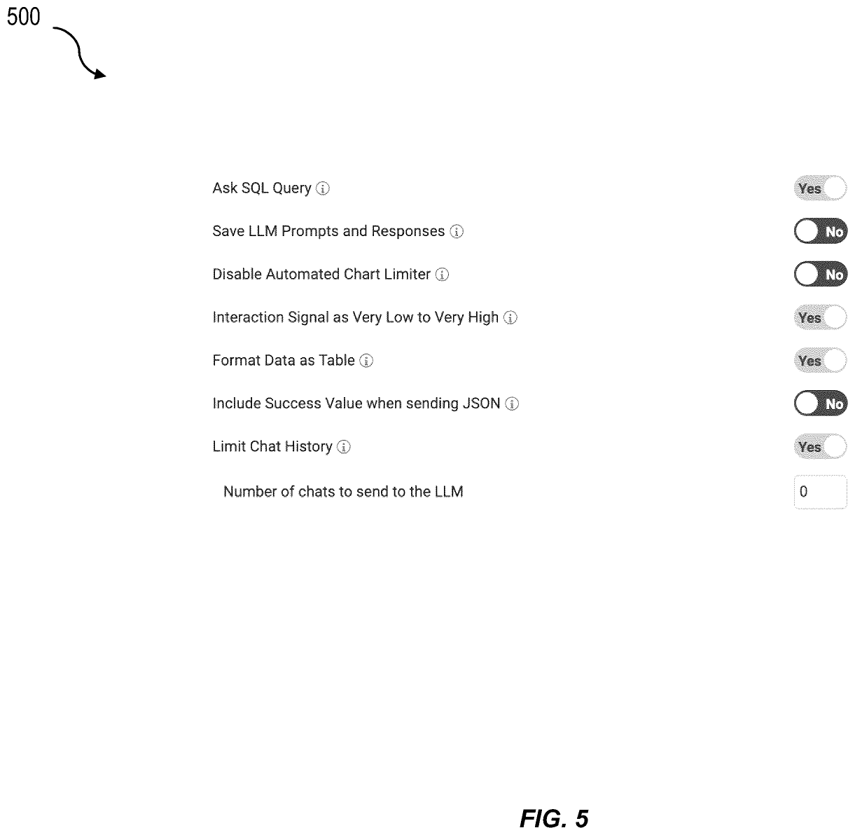

FIG. 5 provides an illustration of an interface 500 of a control system that can manage the flow of information and interaction of the user interface with a user. In some embodiments, the interface 500 may embody a process for generating an enhanced prompt. For example, the interface 500 may be configured to determine what prompts and responses are provided to an artificial intelligence model such as a large language model, determine the number of chats or prompts that are sent to the large language model, and determine whether an enhanced chat or prompt should be sent to the large language model.

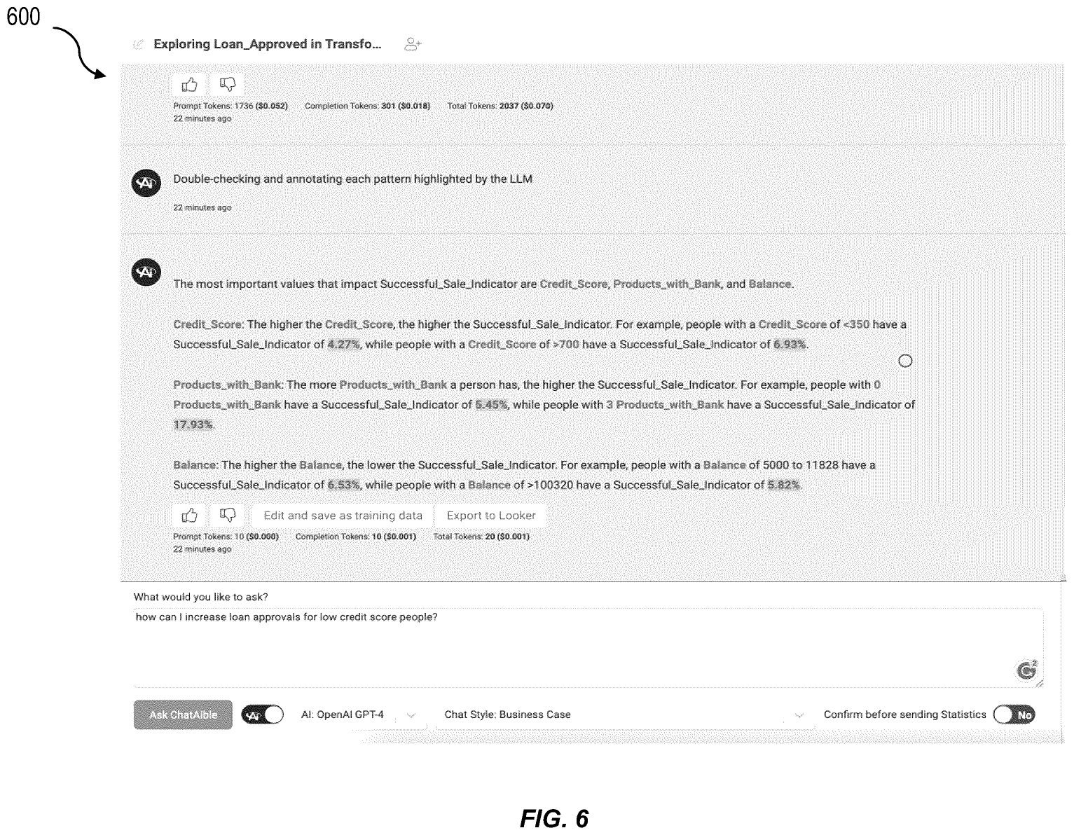

FIG. 6 provides an illustration of an interface 600 that can be used to generate user feedback, which can then be used to improve an artificial intelligence model. In some embodiments, users can provide feedback to the system on which responses provided by the artificial intelligence model were the most relevant or responsive and which were not. Users can then edit the responses provided by the artificial intelligence model to a better response, which can then be saved and used as training data. User feedback, and training data generated by user feedback can be used for reinforcement learning, fine tuning, Low-Rank Adaptation of Large Language Models (LoRA), or other techniques for improving generative AI models. Some improvements may be based at least in part on the enhanced prompts provided to the artificial intelligence model. As shown the user is provided with an option of editing and saving the response of an artificial intelligence model as training data.

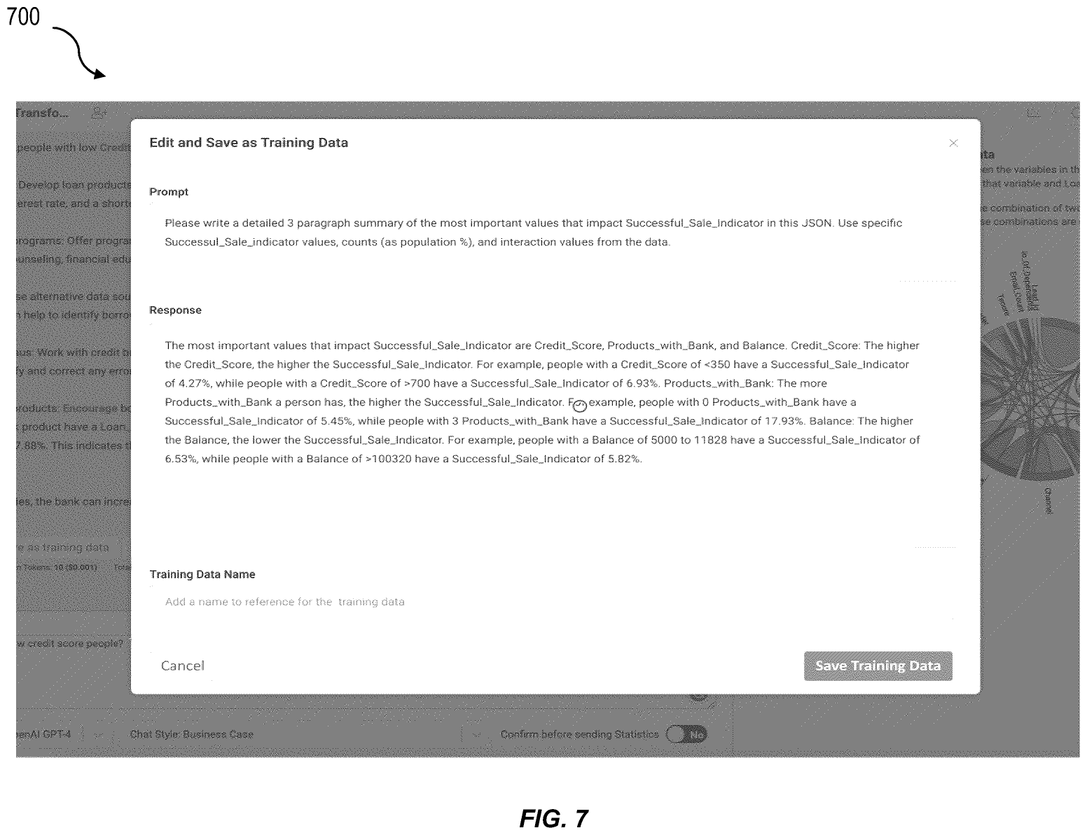

FIG. 7 provides another illustration of an interface 700 that can be used to generate user feedback, which can then be used to improve an artificial intelligence model. As shown, prompts or queries and their corresponding response can be edited and saved as training data by a user. In this manner, the artificial intelligence model may be improved.

In an exemplary embodiment, a system may focus on exploratory analysis of data, and may include an enhanced prompt generator. The enhanced prompt generator may be configured to provide prompt augmentation instructions to enable that use case. The system may also recommend specific generative AI models that are better suited for a specific use case and may recommend the most appropriate settings for each such model. Further, the system may provide Low-Rank Adaptation of Large Language Models (LoRA) data that is specifically focused on enhancing such exploratory analysis responses for the recommended generative AI model and settings.

In this way, the end user may be provided with a better initial experience with the system and is no longer required to figure out what AI model is most appropriate for their use case, or what settings for the chosen AI model is best to use, and the like, before they are able to use the AI model.

In some implementations, a user can provide feedback using thumbs up/down, editing and saving training data, customizing the generative AI model for their specific use case using LoRA or other techniques, or editing the generated enhanced prompts to enhance their experience further. Users can also share the updated methods for enhancing the prompts along with associated assets such as LoRA information to other users. This approach may enable a better initial user experience, massively reduces the user expertise and training required to benefit from the system, and also enables simple end-user led sharable improvements and innovations.

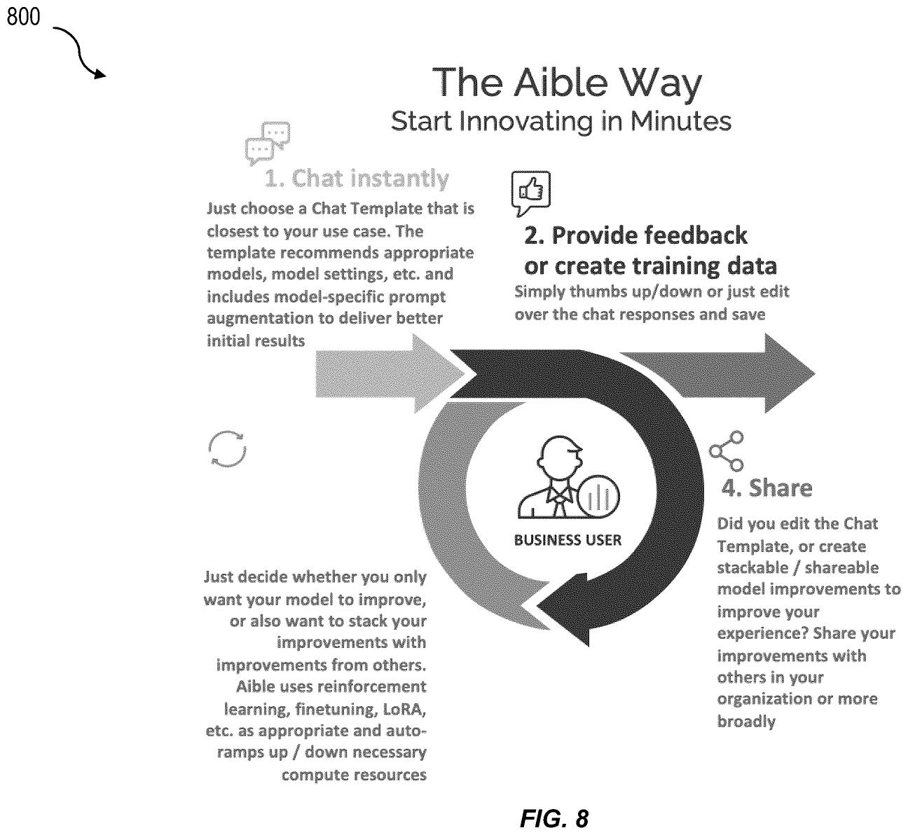

FIG. 8 provides an illustration of a process flow 800 for a system that utilizes enhanced prompts. For example, a user of the system may be configured to choose a use case setting that best resembles the user's use case. The system may then provide recommendations for appropriate AI model selection, AI model settings. The system may also provide enhanced prompts based on the user selection. The system may then provide a user with outputs from the AI model based on their prompts. The user may then provide feedback to the resulting outputs. Optionally, the user may also elect to edit the provided resulting outputs of the AI model to generate additional training data. The user may also edit the prompt template itself. The user may then share the enhanced prompts, prompt templates, feedback, or training data with others, either in an enterprise or organization, or more broadly. The system may then be configured for automatic improvement by incorporating edits from a population, or by using reinforcement learning, fine-tuning, LoRA and the like. The described process flow 800 provides many advantages over conventional systems. For example, conventional systems would have required many iterations between data engineers, data scientists, analysts and businesses users to conduct model turning, and while business users may be provided with access to the final model, the users may not be sure of whether the fine tuning data improved the model.

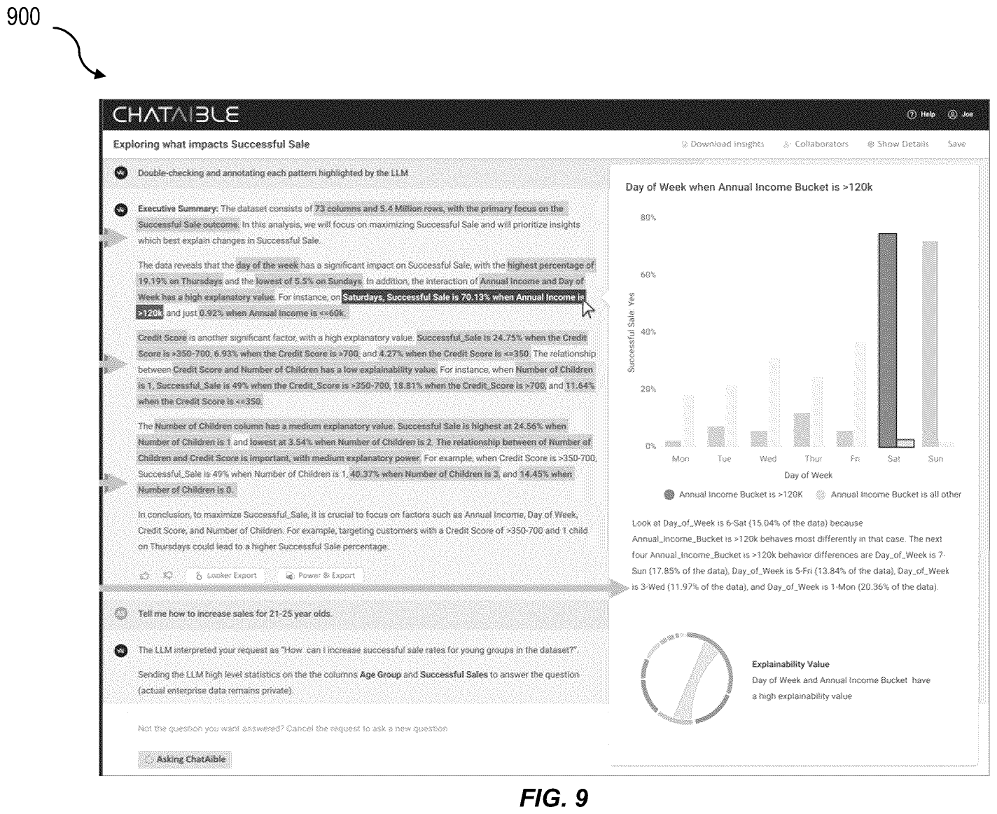

FIG. 9 provides another illustration of an interface 900 that includes a chat feature that is integrated with a prompt generator such as that described in the current subject matter. For example, the chat feature can be used to automatically generate an executive summary as a starting point, optionally, without requiring a user question. The chat feature can also include context information regarding an enterprise and thereby provide context specific answers. Further, the chat feature can verify output from a large language model using color coding or other visual representations. Further the interface may be configured to provide a user with underlying visual representations and charts of the data used to create the executive summary such that they can verify the provided summary. In this manner the user interface may be configured to allow inexpert users to confirm and accept the output of the combined system without requiring any data science expertise.

In some implementations, the generation of enhanced or augmented prompts can be combined with blueprints or guides for a user by observing and modeling historical user behavior. For example, auto-generated blueprints can guide a user, who may be inexperienced in certain types of data analysis, to perform advanced analysis. A blueprint can enable an interface to walk a user through creating an advanced scenario including identifying the appropriate variables, identifying the appropriate data sources (example data sources can be recommended), identifying the appropriate data granularity (e.g. whether each row should represent a customer or an opportunity), identifying specific data columns or rows to include or exclude, and the like. In some implementations, blueprints can be learned from identified enterprise integrations, including identifying appropriate data sets for a particular task.

Enhanced or augmented prompts can also be based on receiving historical user behavior including historical data analysis characteristics and generating, a blueprint for guiding user action to modify the prompt based on the historical data analysis characteristics. For example, prompts entered by a novice user may be enhanced based on analysis of historical data that monitored an expert user and the prompts that were generated by that expert user.

In this way, some implementations of the current subject matter can be used for analytics, predictions, generating recommendations, summarizing documents, prompting documents, self-service models, supporting chat bots and the like. In some implementations, the current subject matter can be used for enterprise applications such as customer relationship management (CRM), enterprise resource planning (ERP), and the like. It is envisioned that a wide variety of user-specific AI-led enterprise application user experiences can integrate the processes for generating enhanced prompts discussed herein.

In some embodiments, the current subject matter may include a context preference template that can be used such that a communication can be written once and then communicated to multiple people, each in their own preferred communication style and channel (e.g., informal message on chat, formal email). In some embodiments, the prompt generator can be embodied within a communication or instant messaging system. In such an embodiment, a user can type or speak the message or notes into the system and the current subject matter can reword and distribute the messages such that everyone receives the communication as they prefer. The current subject matter can also monitor multiple communication channels and run the reverse of the first situation where an individual receives information across channels but those messages are translated and delivered in the preferred style in the preferred channel.

In some embodiments, the current subject matter may use a prompt generator to create templates, or chat templates. In some embodiments, the system may be configured such that one template can refer to related templates either explicitly or by analysis using an artificial intelligence machine (e.g., a generative AI model). Templates may refer to other templates in order to identify additional avenues for exploration. For example, templates of an enterprise may include those for enterprise resource planning (ERP) which would cover Order Management, Financials, Supply Chain, Supplier On-boarding along with those for Supplier Sourcing from supplier catalogs. A user may start with a customer relationship management (CRM) template which includes references to ERP Order Management. Chats with the CRM Chat Template may source referrals to Order Management based on dialogs that reference increasing sales via add-on orders or upsells. The Order Management Chat Template may subsequently source referrals to the Financials or Supplier Sourcing when profitability enters into the dialog. Through this Chat Template referral capability Chat Templates go beyond simple search to facilitating Generative AI creating directed references to related domains of information.

Although a few variations have been described in detail above, other modifications or additions are possible.

The subject matter described herein provides many technical advantages. For example, the subject matter improves artificial intelligence based models by allowing non-technical prompts generated by users to be enhanced in a manner that produces more relevant responses from artificial intelligence based models. Further, it allows the encoding of organizational best practices and applying them consistently to all user interactions. It also allows the creation of user-specific application experiences by enabling the user to train or configure an AI to his/her unique preferences. As users configure AI that conforms to their preferences, communication between users may be adjusted by the AI systems to the unique preferences of the recipient. For example, one user may prefer short bulleted communication, while another prefers more verbose communication. Communication between the two user may be translated such that each receives the communication according to their preference. Further, in some embodiments, providing improved prompts that are enhanced, may prevent an artificial intelligence model from outputting hallucinations or false statements.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a first prompt from a user interface;
generating data characterizing a second prompt, wherein the second prompt is configured to generate a response from an artificial intelligence model that has a greater relevancy than a response from the artificial intelligence model generated by providing the first prompt to the artificial intelligence model;
receiving data characterizing a response to the second prompt by providing the data characterizing the second prompt to an artificial intelligence based model; and
providing the response to the second prompt in the user interface.

2. The method of claim 1, wherein generating the data characterizing the second prompt further comprises:
modifying the received data characterizing the first prompt based on at least one of a type of the artificial intelligence based model, a setting of the artificial intelligence based model, or a configuration for an enterprise in which the artificial intelligence based model is deployed.

3. The method of claim 2, wherein the type of the artificial intelligence based model comprises at least one of a foundational model, a multimodal model, a reinforcement learning model, a transfer learning model, or a large language model.

4. The method of claim 2, wherein the setting of the artificial intelligence based model comprises at least one of a temperature, a frequency penalty, a top P-value, or a top K-value.

5. The method of claim 2, wherein the configuration for the enterprise comprises at least one of language preferences, or data masking preferences.

6. The method of claim 5, wherein the language preferences comprises tone, cadence, or narrative styles.

7. The method of claim 2, wherein the configuration for the enterprise comprises enterprise specific data.

8. The method of claim 7, wherein the enterprise specific data comprises at least one of sales expenditure, marketing expenditure, revenue, win rate, statistics, inventory levels, logistics datasets, collections metrics, or lead conversions.

9. The method of claim 1, wherein the first prompt is provided by the user interface in natural language form.

10. The method of claim 1, wherein the data corresponding to the response to the second prompt is provided to the user interface in natural language form.

11. The method of claim 1, wherein generating the data characterizing the second prompt further comprises:
receiving historical user behavior including historical data analysis characteristics; and
generating, based on the historical data analysis characteristics, a blueprint for modifying the first prompt into the second prompt.

12. The method of claim 11, wherein the blueprint is at least partially automatically generated based on metadata.

13. The method of claim 1, wherein generating data characterizing the second prompt is based at least on user feedback to historical provided prompt responses.

14. The method of claim 1, further comprising:
selecting the artificial intelligence based model based on the second prompt.

15. A system comprising:
at least one data processor; and
memory coupled to the at least one data processor and storing instructions which, when executed by the at least one data processor, causes the at least one data processor to perform operations comprising:
receiving data characterizing a first prompt from a user interface;
generating data characterizing a second prompt, wherein the second prompt is configured to generate a response from an artificial intelligence model that has a greater relevancy than a response from the artificial intelligence model generated by providing the first prompt to the artificial intelligence model;
receiving data characterizing a response to the second prompt by providing the data characterizing the second prompt to an artificial intelligence based model; and
providing the response to the second prompt in the user interface.

16. A non-transitory computer readable storage medium storing computer readable instructions, which, when executed by at least one data processor, causes the at least one data processor to perform operations comprising:
receiving data characterizing a first prompt from a user interface;
generating data characterizing a second prompt, wherein the second prompt is configured to generate a response from an artificial intelligence model that has a greater relevancy than a response from the artificial intelligence model generated by providing the first prompt to the artificial intelligence model;
receiving data characterizing a response to the second prompt by providing the data characterizing the second prompt to an artificial intelligence based model; and
providing the response to the second prompt in the user interface.
